(19) United States
(12) Patent Application Publication
(10) Pub. No.: US 2013/0196298 A1
(43) Pub. Date: Aug. 1, 2013

(54) SYSTEM AND METHOD TO PROMOTE PHYSICAL EXERCISE

(71) Applicant: ICON Health & Fitness, Inc., Logan, UT (US)

(72) Inventors: Scott R. Watterson, Logan, UT (US); David Watterson, Logan, UT (US); Mark D. Watterson, Logan, UT (US)

(73) Assignee: ICON HEALTH & FITNESS, INC., Logan, UT (US)

(21) Appl. No.: 13/754,143

(22) Filed: Jan. 30, 2013

Related U.S. Application Data
(60) Provisional application No. 61/593,290, filed on Jan. 31, 2012.

(51) Int. Cl. G09B 19/00

(52) U.S. Cl. CPC G09B 19/00
USPC 434/236

(57) ABSTRACT

A computer-implemented method to provide a physical activity challenge with an accompanying reward for completing the challenge is provided. Data describing the challenge relating to at least one physical activity is received. Data describing at least one reward for completing the challenge is received. Progress of the challenge is tracked. The tracked progress is analyzed to determine whether the challenge is completed. Upon determining the challenge is completed, the reward is delivered.

### BACKGROUND

Physical exercise is a bodily activity that helps promote and/or maintain physical fitness and an overall health and wellness. Frequent and regular physical exercise helps boost the immune system and may help prevent diseases of affluence, such as heart disease, cardiovascular disease, diabetes, and obesity. Physical exercise may also improve the mental health of an individual. In addition, exercise may prevent depression and promote or maintain a positive self-esteem.

Employers may desire their employees to be physically active. Employees that are active may have more energy to perform their job-related tasks and the tasks may be performed more efficiently. Employees that do not engage in a healthy lifestyle may be more likely to take unnecessary time off work due to illnesses that may have been prevented by engaging in regular physical exercise. As a result, it may be economically beneficial for employers to encourage employees to participate in regular physical activities. In addition to employers, health insurance providers may also strive for ways to encourage their customers to engage in a healthy lifestyle. If health plan participants are healthy, the insurance providers may also reap a benefit economically by processing a reduced number of insurance claims.

Providers of products and/or services relating to physical exercise continuously strive to increase their marketing effectiveness. These providers may constantly look for ways to increase traffic in their store, at their website, etc. The demand for these types of products and/or services will continue to increase as people continue to be actively engaged in physical activities.

As a result, employers, insurance providers, retailers of goods and services, etc. are routinely looking for effective ways to encourage employees, health plan participants, and potential (and existing) customers to be physically active. Numerous benefits for both the individuals that exercise as well as the entity that promotes the exercise may be realized.

One type of reward granting exercise machine is disclosed in U.S. Pat. No. 5,456,648 issued to Peter J. Edinburg et al. In this patent, a preselected work input to an exercise machine is associated with an award-granting switch that triggers a reward when a predetermined threshold is met. The input is a particular rate of work as measured by rotational speed or linear motion or a summation of the time during which a threshold level of work was exceeded, as determined by a plurality of timers and other hardware devices. The reward is turning on an electrical appliance, such as a TV. The reward could also be a change in the exercise machine and regime.

### SUMMARY

In one aspect of the disclosure, a computer-implemented method to provide a physical activity challenge with an accompanying reward for completing the challenge is provided.

Another aspect of the disclosure may include any combination of the above-mentioned features and may further include receiving data describing the challenge relating to at least one physical activity.

Another aspect of the disclosure may include any combination of the above-mentioned features and may further include receiving data describing at least one reward for completing the challenge.

Another aspect of the disclosure may include any combination of the above-mentioned features and may further include tracking progress of the challenge.

Another aspect of the disclosure may include any combination of the above-mentioned features and may further include analyzing the tracked progress to determine whether the challenge is completed.

Another aspect of the disclosure may include any combination of the above-mentioned features and may further include delivering the reward upon determining the challenge is completed.

Another aspect of the disclosure may include any combination of the above-mentioned features and may further include delivering the reward by transmitting an electronic message.

Another aspect of the disclosure may include any combination of the above-mentioned features and may further include the electronic message including the reward.

Another aspect of the disclosure may include any combination of the above-mentioned features and may further include delivering the reward by uploading the reward to an electronic account.

Another aspect of the disclosure may include any combination of the above-mentioned features and may further include monitoring an input to detect an acceptance of the challenge.

Another aspect of the disclosure may include any combination of the above-mentioned features and may further include tracking the progress of the challenge by tracking at least one of a distance factor, a calorie expenditure, a resistance factor, a speed factor, a heart rate factor, a weight factor, a time factor, or a frequency factor.

Another aspect of the disclosure may include any combination of the above-mentioned features and may further include collecting the tracked progress.

Another aspect of the disclosure may include any combination of the above-mentioned features and may further include transmitting the tracked progress to a back-end server.

Another aspect of the disclosure may include any combination of the above-mentioned features and may further include the challenge and the reward originating from a retailing entity, an educational entity, a government entity, an insurance entity, or a manufacturing entity.

Another aspect of the disclosure may include any combination of the above-mentioned features and may further include implementing the method by a computing device integrated within an exercise apparatus.

Another aspect of the disclosure may include any combination of the above-mentioned features and may further include implementing the method by a computing device that is external to an exercise apparatus.

In one aspect of the disclosure, a computing device is also described. The device may include a processor, memory in electronic communication with the processor, and a rewards module, stored in the memory.

Another aspect of the disclosure may include any combination of the above-mentioned features and may further include the rewards module being configured to receive data describing a challenge relating to at least one physical activity.

Another aspect of the disclosure may include any combination of the above-mentioned features and may further include the rewards module being configured to receive data describing at least one reward for completing the challenge.

Another aspect of the disclosure may include any combination of the above-mentioned features and may further include the rewards module being configured to track progress of the challenge.

Another aspect of the disclosure may include any combination of the above-mentioned features and may further include the rewards module being further configured to analyze the tracked progress to determine whether the challenge is completed.

Another aspect of the disclosure may include any combination of the above-mentioned features and may further include, upon determining the challenge is completed, the rewards module being configured to deliver the reward.

In one aspect of the disclosure, a computer-program product is also described. The computer-program product may include a non-transitory computer-readable storage medium having instructions thereon.

Another aspect of the disclosure may include any combination of the above-mentioned features and may further include the instructions including code programmed to receive data describing a challenge relating to at least one physical activity.

Another aspect of the disclosure may include any combination of the above-mentioned features and may further include the instructions including code programmed to receive data describing at least one reward for completing the challenge.

Another aspect of the disclosure may include any combination of the above-mentioned features and may further include the instructions including code programmed to track progress of the challenge.

Another aspect of the disclosure may include any combination of the above-mentioned features and may further include the instructions including code programmed to analyze the tracked progress to determine whether the challenge is completed.

Another aspect of the disclosure may include any combination of the above-mentioned features and may further include, upon determining the challenge is completed, the instructions including code programmed to deliver the reward.

### BRIEF DESCRIPTION OF THE DRAWINGS

The accompanying drawings illustrate various embodiments of the present method and system and are a part of the specification. The illustrated embodiments are merely examples of the present system and method and do not limit the scope thereof

FIG. 1 illustrates a block diagram of one embodiment of an environment in which the present systems and methods may be implemented.

FIG. 2 is a block diagram illustrating one embodiment of a client device.

FIG. 3 is a block diagram illustrating one configuration of a tracking module.

FIG. 4 is a block diagram illustrating one embodiment of a delivery module.

FIG. 5 is a block diagram illustrating one example of a server.

FIG. 6 is a flow diagram illustrating one embodiment of a method to provide an incentive relating to the completion of a physical activity.

FIG. 7 is a flow diagram illustrating one embodiment of a method to collect and transmit challenges and related rewards.

FIG. 8 depicts a block diagram of a computer system suitable for implementing the present systems and methods.

Throughout the drawings, identical reference numbers designate similar, but not necessarily identical, elements.

### DETAILED DESCRIPTION

Systems and methods to provide incentives or rewards for engaging in physical activities are disclosed herein. Specifically, the present systems and methods provide physical activity challenges with an accompanying reward for completing the challenge. In addition, the present systems and methods may track a user's progress with respect to the challenge and provide the user the reward upon detecting the completion of the challenge. The challenge may be to exercise for a certain amount of time, run/walk/bike a certain distance, climb a certain number of vertical feet, etc. The reward or incentive for completing such a challenge may include discounts on merchandising, rebates, discounts on health insurance premiums, tuition credits, and the like.

In one embodiment, the challenge and accompanying incentive may be provided by an entity that provides certain products and/or services. The reward may include discounts, coupons, etc. on the merchandise and/or services provided by the entity. The user may decide to accept the challenge and upon completing the challenge, the user may be provided the reward.

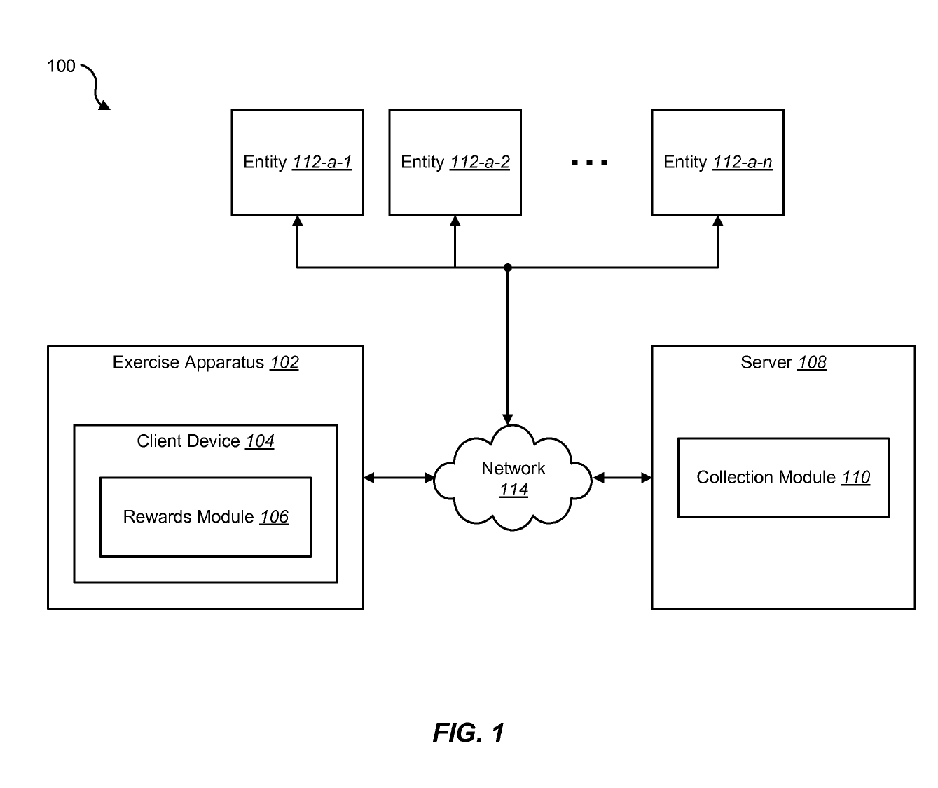

Referring now to the Figures, FIG. 1 illustrates a block diagram of one embodiment of an environment 100 in which the present systems and methods may be implemented. In one configuration, an exercise apparatus 102 may include a client device 104. In another example, the client device 104 may be separate and external to the exercise apparatus 102. For example, the client device 104 may be a mobile communications device (such as a smartphone) that communicates (e.g., wirelessly or wired) with the exercise apparatus 102. The apparatus 102 may be, but is not limited to, a treadmill, a stationary bicycle, a stair-climbing machine, an elliptical machine, an elliptical trainer, a glider machine, a rowing machine, and the like. The client device 104 may be a computing device that includes at least a processor, memory, and one or more I/O devices (such as a display, keyboard, etc.). The client device 104 may further include a rewards module 106. The module 106 may include one or more instructions that are executed by the processor to perform certain functions. In one embodiment, the rewards module 106 may provide a challenge to a user, track the user's progress in completing the challenge, and provide the accompanying reward to the user upon completion of the challenge. Details regarding the rewards module 106 will be described below.

In one embodiment, the client device 104 may communicate with a server 108 across a network 114 connection. The network 114 connection may include, but is not limited to, a Wide Area Local Access Network (WLAN), a cellular network (e.g., 3G, 4G, etc.), a Wi-Fi network, and the like. The server 108 may include a collection module 110 to collect information from the client device 102 as well as information from a number of entities 112. The server 108 may transmit information to the client device 104 that is collected from the entities 112. In one configuration, the entities 112 may communicate the information to the server 108 and/or directly to the client device 104. In one embodiment, the entities 112 may transmit information that includes challenges and incentives for completing the challenges. The entities 112 may be providers of products and/or services. For example, the entities 112 may include retailers of merchandise, educational institutions, insurance providers, government entities, service providers, and the like. The collection module 110 may also collect information from the client device 104 that indicates whether a particular challenge was accepted and completed. This information may be passed to the entity 112 that provided the original challenge to allow the entity 112 to determine if that particular challenge was successful. For example, a retailer of merchandise may issue a challenge to run a certain distance within a week's time period. The reward may include a discount on a certain piece of merchandise. The collection module 110 may collect information from a number of client devices 104 that indicates the number of users that accepted the challenge and successfully completed the challenge. As a result, the retailer may assess the successfulness of that particular challenge and reward.

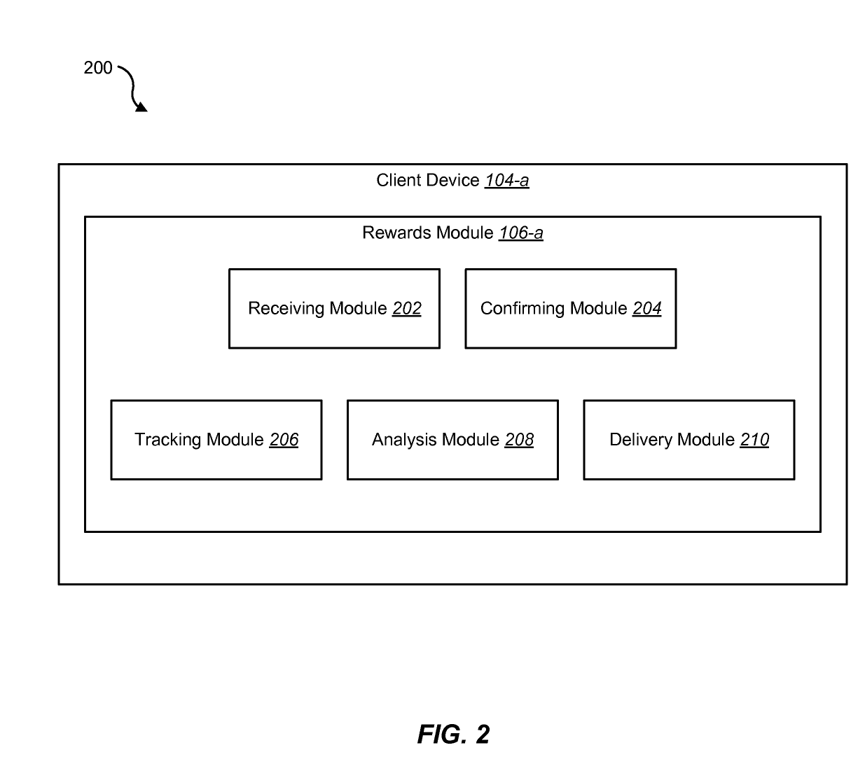

FIG. 2 is a block diagram illustrating one embodiment of a client device 104-a. The device 104-a may be an example of the client device 104 of FIG. 1. In one configuration, the client device 104-a may include a rewards module 106-a. The rewards module 106-a may provide challenges and rewards for completing the challenges. The module 106-a may include a receiving module 202, a confirming module 204, a tracking module 206, an analysis module 208, and a delivery module 210.

In one embodiment, the receiving module 202 may receive information describing one or more challenges and rewards. The module 202 may receive the information from the collection module 110 and/or directly from the entity 112 that issues the challenge and accompanying reward. The confirming module 204 may detect an input from an I/O device to determine whether the user has accepted the challenge. For example, the confirming module 204 may detect the selection of a button on a keyboard or touch screen display of the client device 104-a indicating the user accepts the challenge. The confirming module 204 may also detect an outgoing SMS message or email message from the client device 104-a to determine the user has accepted the challenge. For example, the client device 104-a may receive the challenge via a SMS message. The user may transmit a SMS message in response to indicate his/her acceptance of the challenge. The confirming module 204 may detect if a SMS message is transmitted in response to the received SMS message that includes the challenge.

In one configuration, the tracking module 206 may track the progress of the user with respect to a challenge. For example, the tracking module 206 may communicate with the exercise apparatus 102 to track the distance the user has ran/walked/biked. The tracking module 206 may also track the vertical feet the user has climbed, the length of time the user has used the apparatus 102, etc. The tracking module 206 may also track information relating directly to the user. For example, the module 206 may track biometric information of the user, such as heart rate, weight, etc. In one configuration, the module 206 may track the progress of the user continually and/or after the user has accepted a challenge.

The analysis module 208 may analyze the progress tracked by the tracking module 208 to determine whether the user has completed the challenge. For example, the user may accept a challenge to run a distance of 3 miles. The tracking module 206 may track the distance the user has run and the analysis module 208 may determine when the user has completed 3 miles. When the analysis module 208 determines the challenge has been satisfied, the delivery module 210 may deliver the reward associated with the challenge. For example, the module 210 may provide a code for the user to use during his/her next purchase which will provide a discount. The module 210 may transmit an email or SMS message with the reward (such as a coupon or other discount). The reward may also include a certain number of points. The user may accumulate points and trade the points for certain products and services. The delivery module 210 may upload the number of points awarded to the user for completing the challenge to a website. The website may include an online account of points the user has acquired for completing challenges.

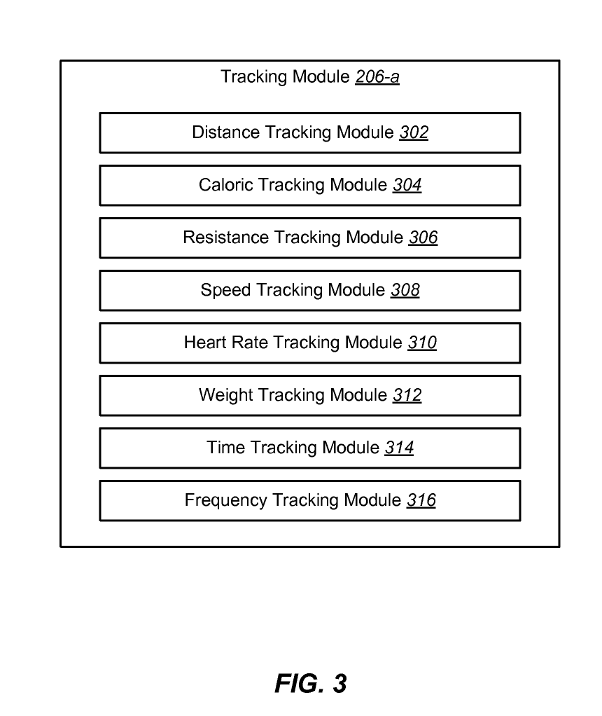

FIG. 3 is a block diagram illustrating one configuration of a tracking module 206-a. The tracking module 206-a may be an example of the tracking module 206 of FIG. 2. In one embodiment, the module 206-a may include a distance tracking module 302, a caloric tracking module 304, a resistance tracking module 306, a speed tracking mould 308, a heart rate tracking module 310, a weight tracking module 312, a time tracking module 314, and a frequency tracking module 316. The various modules of the tracking module 206-a may communicate with the exercise apparatus 102 to collect information relating to a particular tracking category. One or more of the modules may also communicate with a device connected to the user to track certain measurements of the user. For example, the heart rate tracking module 310 may communicate with the exercise apparatus 102 to track the user's heart rate, as measured by the apparatus 102. The module 310 may also communicate with a device (such as a heart monitor chest strap, heart monitor watch, etc.) worn by the user to track the user's heart rate.

In one configuration, the distance tracking module 302 may track the distance the user has traveled while using the exercise apparatus 302. For example, the module 302 may track the number of miles ran/walked/biked by the user. In another embodiment, the module 302 may communicate with a device worn by the user to track the distance traveled. For example, instead of using the exercise apparatus 102, the user may run/walk/bike outside without the apparatus 102. The user may wear a watch or smart phone that tracks the distance ran/walked by the user. The distance tracking module 302 may communicate with the watch or smart phone to track the distance traveled by the user.

In one example, the caloric tracking module 304 may track the number of calories burned by the user during a period of time. The module 304 may track this information directly from the exercise apparatus 102 and/or from a device (such as a watch) worn by the user. The resistance tracking module 306 may track the level of resistance performed by the user. For example, the module 306 may track the vertical feet the user has traveled using the exercise apparatus 102 and/or a device worn by the user that measures the change in altitude the user has traveled. If the apparatus 102 is a stationary bicycle (e.g., a spinner bicycle), the module 306 may track the level of resistance applied to the tires of the bicycle. A higher level of resistance may require an increased amount of effort from the user.

The speed tracking module 308 may track the speed of the exercise apparatus 102. For example, the user may program a treadmill for a certain speed. The module 308 may communicate with the treadmill to monitor this speed. In another embodiment, the user may wear a device that monitors the speed of the user. The module 308 may communicate with this device to obtain the speed of the user.

The heart rate tracking module 310 may track the heart rate of the user. For example, the exercise apparatus 102 may obtain the heart rate of the user. The module 310 may communicate with the apparatus 102 to obtain the heart rate measurements. In another embodiment, the user may wear a heart rate monitoring strap. The module 310 may obtain the heart rate measurements by receiving a signal from the monitoring strap. The weight tracking module 312 may track the weight of the user. The tracked weight may include body weight, percentage of body fat, etc. For example, the exercise apparatus 102 may acquire weight information for the user. The module 312 may track the weight of the user by communicating with the apparatus 102.

The time tracking module 314 may track the amount of time a user exercises on the apparatus 102. In addition, the module 314 may track the amount of time the user exercises outside without the apparatus 102 by communicating with a watch or other device that records the amount of time the user is exercising. The frequency tracking module 316 may track how often the user exercises on the apparatus 102 by communicating with the apparatus 102. For example, the module 316 may determine that the user exercised 3 days a week on the treadmill. In addition to the various modules automatically tracking information, the user may manually enter the information to the modules.

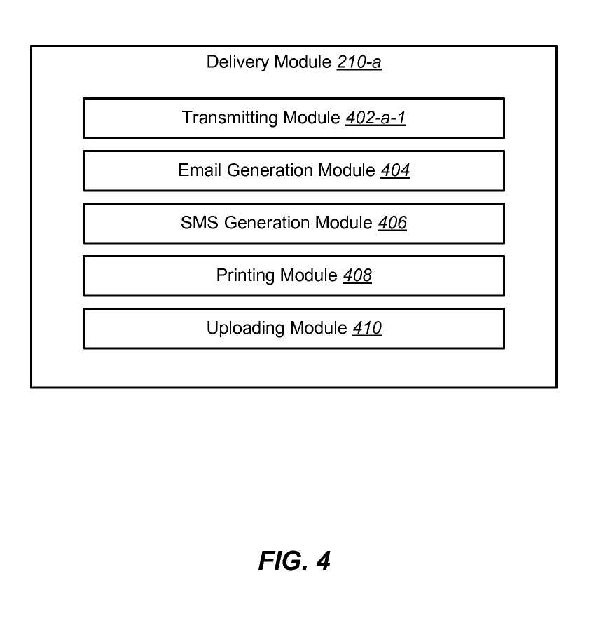

FIG. 4 is a block diagram illustrating one embodiment of a delivery module 210-a. The module 210-a may be an example of the delivery module 210 of FIG. 2. In one example, the delivery module 210-a may provide a reward to a user upon the user completing a challenge linked to the reward. The module 210-a may include a transmitting module 402-a-1, an email generation module 404, an SMS generation module 406, a printing module 408, and an uploading module 410.

In one embodiment, the transmitting module 402-a-1 may transmit the reward to a particular device. For example, the email generation module 404 may generate an email message that includes the reward (e.g. a coupon, discount, promotional code, etc.). The transmitting module 402-a-1 may transmit the generated email to an email address associated with the user. Similarly, the SMS generation module 406 may generate an SMS message that includes the reward. The transmitting module 402-a-1 may transmit the message to a user's device, such as a cellular telephone.

In one configuration, the printing module 408 may cause the reward to be transmitted (via the transmitting module 402-a-1) to a printing device. As a result, a coupon or other type of reward may be printed and the user may obtain a hard copy of the reward. The uploading module 410 may upload points (or some other indicator) to an online account for the user. The account may accumulate points which the user may trade in for merchandise, services, etc.

In one configuration, the reward may be actual merchandise (e.g., a free pair of running shoes, running shorts, water bottles, etc.). The transmitting module 402-a-1 may transmit information to the server 108 indicating that the user has completed a challenge. The server 108 may store address and other contact information for the user. This information may be transmitted to the entity 112 that provided the challenge. The entity 112 may then send the actual merchandise to the user. In another embodiment, the transmitting module 402-a-1 may transmit information directly to the entity 112 indicating that the user completed the challenge. The module 402-a-1 may also transmit the contact information for the user directly to the entity 112.

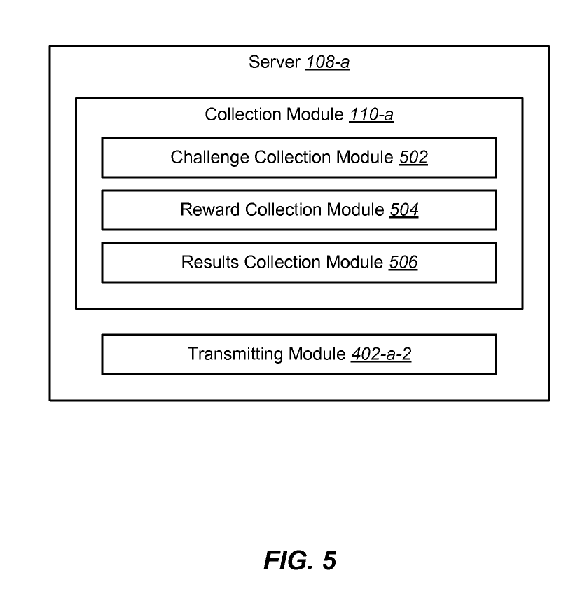

FIG. 5 is a block diagram illustrating one example of a server 108-a. The server 108-a may be an example of the server 108 of FIG. 1. In one configuration, the server 108-a may include a collection module 110-a. The module 110-a may include a challenge collection module 502, a reward collection module 504, and a results collection module 506. The server 108-a may further include a transmitting module 402-a-2.

In one configuration, the challenge collection module 502 may collect challenges submitted by one or more entities 112 in communication with the server. The challenge may indicate the type of physical activity and certain requirements that need to be satisfied to earn the reward (e.g., run a certain distance, reach a certain heart rate, burn a number of calories, etc.). The reward collection module 504 may collect rewards that are associated with the collected challenges. The rewards may include coupons, discounts, promotional codes to retrieve actual merchandise/services, points to accumulate in an online account, memberships, and the like. In one configuration, the results collection module 506 may collect results related to a challenge. For example, the module 506 may collect information that indicates whether or not a user successfully completed a particular challenge.

In one embodiment, the transmitting module 402-a-2 may transmit the collected challenges to the client device 104. The transmitting module 402-a-2 may also transmit information regarding the reward associated with each challenge to the client device 104. By receiving this information, the user may decide whether or not to accept the challenge based on the reward offered for completing the challenge. The transmitting module 402-a-2 may also transmit the actual reward (e.g., coupon, discount codes, etc.) to the client device upon completion of the challenge. Further, the transmitting module 402-a-2 may transmit results for a particular challenge to the entity 112 that originated the challenge. Consequently, the entity 112 may analyze the results to determine the number of users that accepted the challenge, the number of users that completed the challenge, etc.

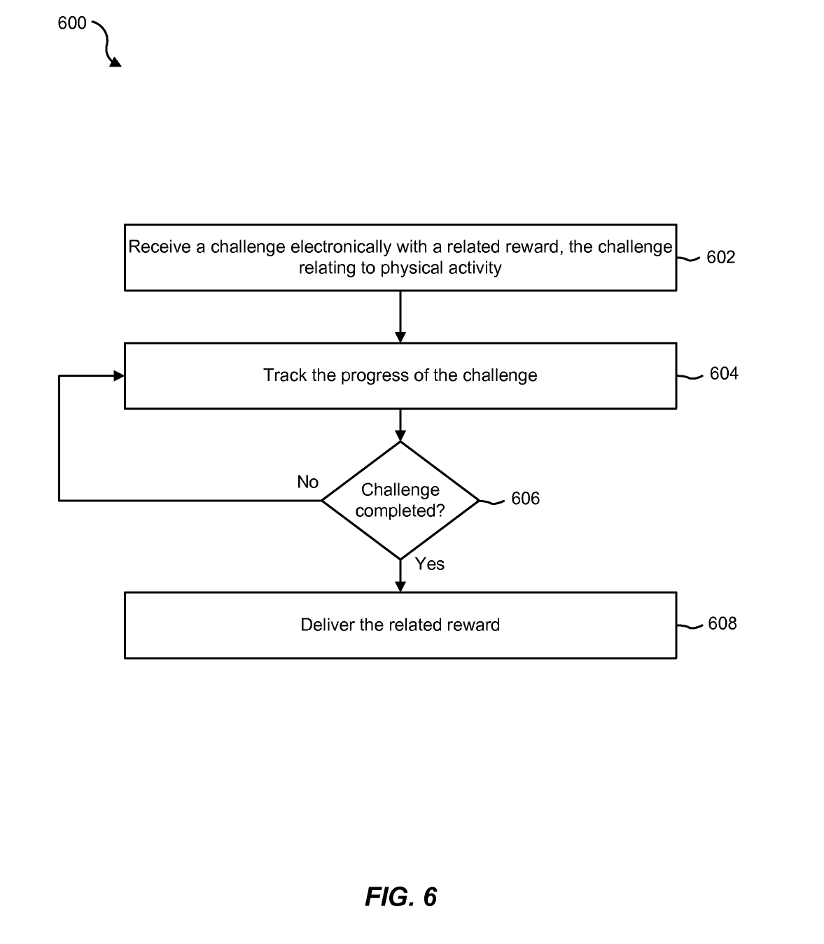

FIG. 6 is a flow diagram illustrating one embodiment of a method 600 to provide an incentive relating to the completion of a physical activity. In one configuration, the method 600 may be implemented by the client device 104 of FIG. 1 or 2. In particular, the method 600 may be implemented by the rewards module 106 of FIG. 1 or 2.

At block 602, a challenge with a related reward may be received electronically. The challenge may be related to a physical activity. For example, the challenge may be to walk five miles at a pace of 13 minutes per mile. The related reward for completing the challenge may be a coupon for 20% off the price of running shoes made by Company X. The challenge and reward may be issued by a retailer of the shoes manufactured by Company X. In another embodiment, Company X may issue the challenge and reward directly. At block 604, the progress of the challenge may be tracked. For example, the distance the user walks on a treadmill (or other exercise apparatus 102 used for walking) may be tracked. In addition the pace or speed the user is walking may also be tracked. For example, the rewards module 106 may communicate with the exercise apparatus 102 to determine the distance and speed of the user.

At block 606, a determination may be made as to whether the challenge has been completed. Using the above example, a determination may be made as to whether the user has walked a distance of five miles at a pace of 13 minutes per mile. If it is determined that the challenge has not been completed, the method 600 may return to continue tracking the progress of the challenge. If, however, it is determined that the challenge has been completed, at block 608, the related reward may be delivered. For example, an email or SMS message may be sent to the user with the coupon, discount code, etc. providing 20% off the price of running shoes made by Company X.

Thus, the method 600 may provide a physical activity challenge and a reward for completing the challenge. The progress towards completing the challenge may be tracked and the reward may be delivered upon completion of the challenge. It should be noted that the method 600 is just one implementation and that the operations of the method 600 may be rearranged or otherwise modified such that other implementations are possible.

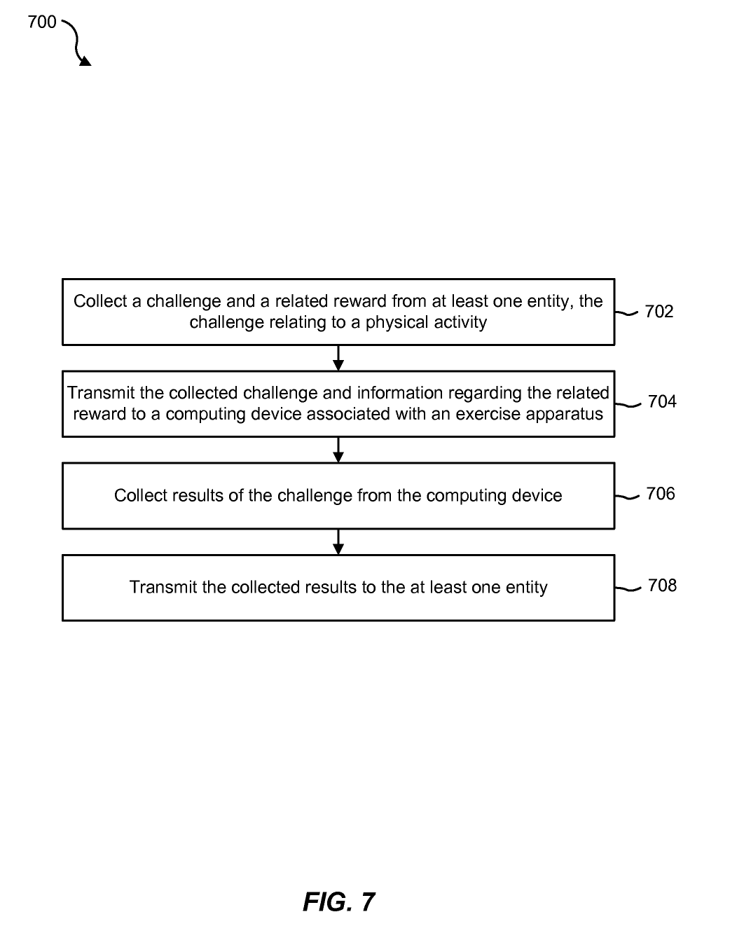

FIG. 7 is a flow diagram illustrating one embodiment of a method 700 to collect and transmit challenges and related rewards. The method 700 may be implemented by the server 108 of FIG. 1 or 5. In particular, the method 700 may be implemented by the collection module 110 of FIG. 1 or 5.

At block 702, a challenge and a related reward may be collected from at least one entity 112. The challenge may relate to a physical activity. The entity 112 may include a retailer, a manufacturer, an educational institution, a government entity, an insurance company, an employer, and the like. At block 704, the collected challenge and information regarding the related reward may be transmitted to a computing device (such as the client device 104). The computing device may be associated with or in communications with an exercise apparatus 102. At block 706, the results of the challenge may be collected from the computing device. At block 708, the collected results may be transmitted to the at least one entity 112 that provided the challenge.

Thus, the method 700 may provide for collecting and transmitting a physical activity challenge and a reward for completing the challenge. Results of the challenge may be collected and transmitted to the entity the originated the challenge for further analysis. It should be noted that the method 700 is just one implementation and that the operations of the method 700 may be rearranged or otherwise modified such that other implementations are possible.

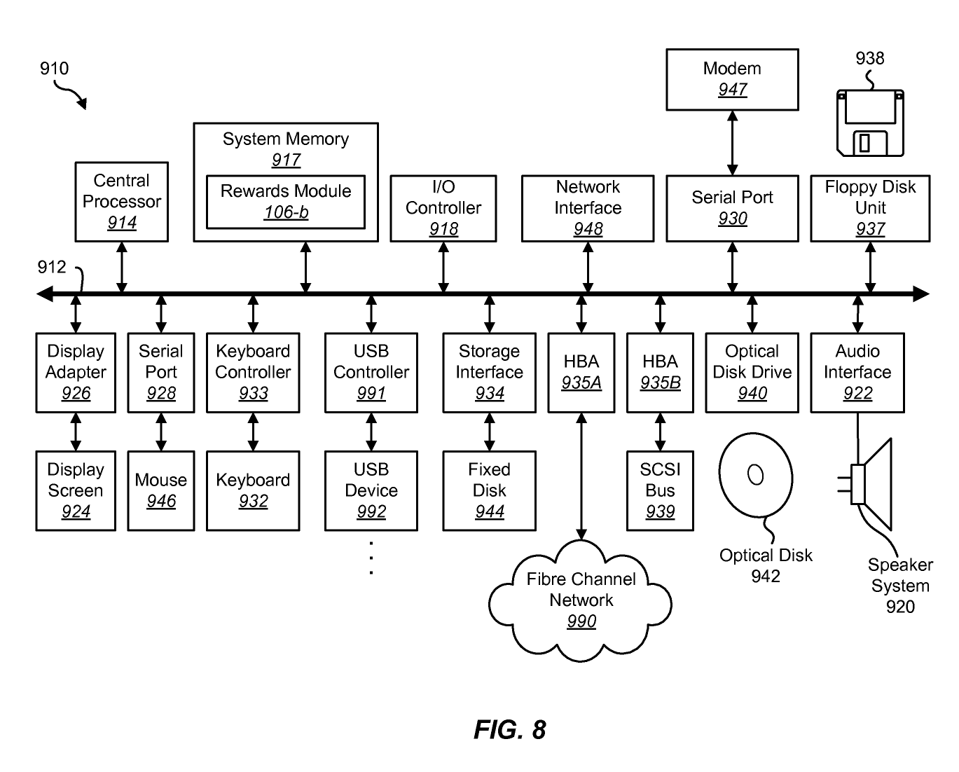

FIG. 8 depicts a block diagram of a computer system 810 suitable for implementing the present systems and methods. The computer system 810 may be an example of the client device 104 of FIG. 1. Computer system 810 includes a bus 812 which interconnects major subsystems of computer system 810, such as a central processor 814, a system memory 817 (typically RAM, but which may also include ROM, flash RAM, or the like), an input/output controller 818, an external audio device, such as a speaker system 820 via an audio output interface 822, an external device, such as a display screen 824 via display adapter 826, serial ports 828 and 830, a keyboard 832 (interfaced with a keyboard controller 833), multiple USB devices 892 (interfaced with a USB controller 891), a storage interface 834, a floppy disk unit 837 operative to receive a floppy disk 838, a host bus adapter (HBA) interface card 835A operative to connect with a Fibre Channel network 890, a host bus adapter (HBA) interface card 835B operative to connect to a SCSI bus 839, and an optical disk drive 840 operative to receive an optical disk 842. Also included are a mouse 846 (or other point-and-click device, coupled to bus 812 via serial port 828), a modem 847 (coupled to bus 812 via serial port 830), and a network interface 848 (coupled directly to bus 812).

Bus 812 allows data communication between central processor 814 and system memory 817, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the rewards module 106-b may be stored within the system memory 817 to implement the present systems and methods. Applications resident with computer system 810 are generally stored on and accessed via a non-transitory computer readable medium, such as a hard disk drive (e.g., fixed disk 844), an optical drive (e.g., optical drive 840), a floppy disk unit 837, or other storage medium. Additionally, applications can be in the form of electronic signals modulated in accordance with the application and data communication technology when accessed via network modem 847 or interface 848.

Storage interface 834, as with the other storage interfaces of computer system 810, can connect to a standard computer readable medium for storage and/or retrieval of information, such as a fixed disk drive 844. Fixed disk drive 844 may be a part of computer system 810 or may be separate and accessed through other interface systems. Modem 847 may provide a direct connection to a remote server via a telephone link or to the Internet via an internet service provider (ISP). Network interface 848 may provide a direct connection to a remote server via a direct network link to the Internet via a POP (point of presence). Network interface 848 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., scanners, digital cameras and so on). Conversely, all of the devices shown in FIG. 8 need not be present to practice the present systems and methods. The devices and subsystems can be interconnected in different ways from that shown in FIG. 8. The operation of a computer system such as that shown in FIG. 8 is readily known in the art and is not discussed in detail in this application. Code to implement the present disclosure can be stored in a non-transitory computer-readable medium such as one or more of system memory 817, fixed disk 844, optical disk 842, or floppy disk 838. The operating system provided on computer system 810 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

### INDUSTRIAL APPLICABILITY

In order to motivate a user to begin exercising, continue exercising, and to enjoy their workout, the present system and methods rewards users for completing a certain physical challenge. In general, the system and methods of the present disclosure provide a rewards program that includes sending challenges to users and (if the user accepts the challenge) tracking the progress of the user to complete the challenge. Upon completing the challenge, the user may be rewarded.

Details regarding the challenge and the reward for completing the challenge may be presented to the user via a display on a computer screen, a smartphone, tablet, or any other type of computing device with a screen. In addition, exercise equipment that includes a display may also provide the information regarding the challenge and reward to the user. Selecting an input button on the computing device (or on the exercise machine) may indicate that the user has accepted the challenge. The computing device may be integrated as part of the exercise machine or it may be external and communicate wirelessly with the machine. The integration of the device within the exercise machine and the communication link between an external device and the machine allows the computing device to track the progress of the user as he/she uses the exercise machine. The progress may be tracked to determine when/if the user completes the challenge. For example, the user may receive a challenge to run 5 miles on a treadmill in 50 or less minutes. For completing this challenge, the reward may be a discount on health insurance premiums for the user. As the user runs on the treadmill, the distance and elapsed time may be tracked by the computing device, which may be integrated within the treadmill or in communications with the treadmill. When the user completes the challenge, the user may receive a coupon or other medium that the user may redeem to receive the discount on the insurance premiums.

The ability to track the user's progress and provide incentives for completing challenges allows providers to promote their products/services while encouraging users to stay physically active. Employers may issue challenges to encourage employees to stay in shape by providing monetary (or other incentives) for completing such challenges. Government entities may promote healthy lifestyles by issuing challenges that, if completed, result in tax rebates, tuition discounts, etc. for the user. As stated above, health insurance providers may reward users the complete challenges with discounts on insurance premiums. The reward may be monetary prizes, discounts on products/services, etc. In addition, the incentive may be a certain number of “points” that may be deposited to a user's account. The user may accumulate a certain number of points and exchange these points for a variety of products/services. Providers of the current systems and methods may charge advertising fees to the entities that wish to issue a challenge and reward.

The tracking disclosed herein is performed automatically. As a result, there is no need for the user to manually record and monitor the distance, speed, time, etc. that are required to complete the challenge, as such manual tracking may discourage users from participating in the challenges. The user may browse through various challenges and select the challenges the user wishes to perform. The user may also filter the browsing based on the rewards being offered and select the challenge to perform based on the offered incentive for completing the challenge.

In conclusion, the present systems and methods provides for a mechanism by which retailers, employers, manufacturers, government entities, educational institutions, etc. may submit an exercising challenge directly to exercise machines and/or computing devices that may communicate with the exercise machines (e.g., smartphones, laptops, tablets, and the like). Recipients of the challenge may accept or reject the challenge. If the challenge is accepted, the progress of the user with regards to completing the challenge may be monitored and tracked. When the challenge has been completed, the user may receive a reward. The reward may be emailed or mailed to the user. In addition, the reward may be deposited to an account owned by the user. As a result, the present systems and methods provide incentives for businesses to submit challenges because the reward associated with the challenge may increase customer traffic to the business as well as awareness about the products/services offered by the businesses. The present systems and methods further provide an incentive for users to accept challenges and exercise because of the rewards being offered for completing such challenges.

What is claimed is:

1. A computer-implemented method, comprising:
receiving, by a hardware processor, data describing a challenge relating to at least one physical activity;
receiving, by the hardware processor, data describing at least one reward for completing the challenge;
tracking, by the hardware processor, progress of the challenge;
analyzing, by the hardware processor, the tracked progress to determine whether the challenge is completed; and
upon determining the challenge is completed, delivering, by the hard processor, the reward.

2. The method of claim 1, wherein delivering the reward comprises transmitting an electronic message, wherein the electronic message comprises the reward.

3. The method of claim 1, wherein delivering the reward comprises uploading the reward to an electronic account.

4. The method of claim 1, further comprising monitoring an input to detect an acceptance of the challenge.

5. The method of claim 1, wherein tracking the progress of the challenge further comprises tracking at least one of a distance factor, a calorie expenditure, a resistance factor, a speed factor, a heart rate factor, a weight factor, a time factor, or a frequency factor.

6. The method of claim 1, further comprising:
collecting the tracked progress; and
transmitting the tracked progress to a back-end server.

7. The method of claim 1, wherein the challenge and the reward originate from a retailing entity, an educational entity, a government entity, an insurance entity, or a manufacturing entity.

8. The method of claim 1, wherein the method is implemented by a computing device integrated within an exercise apparatus.

9. The method of claim 1, wherein the method is implemented by a computing device that is external to an exercise apparatus.

10. A computing device, comprising:
a processor;
memory in electronic communication with the processor;
a rewards module, stored in the memory, the rewards module configured to:
receive data describing a challenge relating to at least one physical activity;
receive data describing at least one reward for completing the challenge;
track progress of the challenge;
analyze the tracked progress to determine whether the challenge is completed; and
upon determining the challenge is completed, deliver the reward.

11. The computing device of claim 10, wherein delivering the reward comprises the rewards module being further configured to transmit an electronic message, wherein the electronic message comprises the reward.

12. The computing device of claim 10, wherein delivering the reward comprises the rewards module being further configured to upload the reward to an electronic account.

13. The computing device of claim 10, wherein the rewards module is further configured to monitor an input to detect an acceptance of the challenge.

14. The computing device of claim 10, wherein tracking the progress of the challenge comprises the rewards module being further configured to track at least one of a distance factor, a calorie expenditure, a resistance factor, a speed factor, a heart rate factor, a weight factor, a time factor, or a frequency factor.

15. The computing device of claim 10, wherein the rewards module is further configured to:
collect the tracked progress; and
transmit the tracked progress to a back-end server.

16. The computing device of claim 10, wherein the challenge and the reward originate from a retailing entity, an educational entity, a government entity, an insurance entity, or a manufacturing entity.

17. The computing device of claim 10, wherein the computing device is integrated within an exercise apparatus.

18. A computer-program product, the computer-program product comprising a non-transitory computer-readable storage medium having instructions thereon, the instructions comprising:
code programmed to receive data describing a challenge relating to at least one physical activity;
code programmed to receive data describing at least one reward for completing the challenge;
code programmed to track progress of the challenge;
code programmed to analyze the tracked progress to determine whether the challenge is completed; and
upon determining the challenge is completed, code programmed to deliver the reward.

19. The computer-program product of claim 18, wherein the instructions comprising code programmed to deliver the reward further comprise code programmed to transmit an electronic message, wherein the electronic message comprises the reward.

20. The computer-program product of claim 18, wherein the instructions comprising code programmed to deliver the reward further comprise code programmed to upload the reward to an electronic account.
